(19) United States
(12) Patent Application Publication
(10) Pub. No.: US 2024/0079712 A1
(43) Pub. Date: Mar. 7, 2024

(54) TRACTION BATTERY PACK DIVIDERS AND VENT PATH ESTABLISHING METHOD

(71) Applicant: Ford Global Technologies, LLC, Dearborn, MI (US)

(72) Inventors: Mohammadreza Eftekhari, Novi, MI (US); Daniel Benjamin Kok, Ann Arbor, MI (US); Patrick Daniel Maguire, Ann Arbor, MI (US); Brock Dunlap, Dearborn, MI (US); Michael E. Reibling, Sterling Heights, MI (US)

(21) Appl. No.: 18/153,422

(22) Filed: Jan. 12, 2023

Related U.S. Application Data
(60) Provisional application No. 63/403,445, filed on Sep. 2, 2022.

(51) Int. Cl. H01M 50/291; B60L 50/64; H01M 50/204; H01M 50/244; H01M 50/271; H01M 50/293

(52) U.S. Cl. CPC H01M 50/291; B60L 50/64; H01M 50/204; H01M 50/244; H01M 50/271; H01M 50/293; H01M 2220/20

(57) ABSTRACT

A traction battery pack assembly includes a battery pack enclosure that provides an interior area, and at least one cell stack that includes battery cells and at least one divider distributed along a cell stack axis. The at least one divider compartmentalizes the interior area into a plurality of compartments. Each of the compartments holds at least one of the battery cells.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to compartmentalizing areas of a traction battery pack to facilitate venting battery cells of the traction battery pack.

### BACKGROUND

A traction battery pack of an electrified vehicle can include groups of battery cells arranged in one or more cell stacks. From time to time, pressure and thermal energy within one or more of the battery cells can increase. In response, gases and debris can be released from those battery cells.

### SUMMARY

In some aspects, the techniques described herein relate to a traction battery pack assembly, including: a battery pack enclosure that provides an interior area; and at least one cell stack that includes a plurality of battery cells and at least one divider distributed along a cell stack axis, the at least one divider compartmentalizing the interior area into a plurality of compartments, each of the compartments holding at least one of the battery cells.

In some aspects, the techniques described herein relate to an assembly, wherein the at least one divider is biased against the battery pack enclosure.

In some aspects, the techniques described herein relate to an assembly, wherein the at least one divider is biased against an enclosure cover of the battery pack enclosure.

In some aspects, the techniques described herein relate to an assembly, wherein the at least one divider is adhered to the battery pack enclosure, a beam of the battery pack enclosure, or both.

In some aspects, the techniques described herein relate to an assembly, wherein the at least one divider is at least one metal or metal alloy divider.

In some aspects, the techniques described herein relate to an assembly, wherein the at least one divider includes a fin portion that projects outward from the cell stack axis past the plurality of battery cells.

In some aspects, the techniques described herein relate to an assembly, wherein the fin portion includes a first section bent toward an axial end of the cell stack, and a second section bent away from the axial end of the cell stack.

In some aspects, the techniques described herein relate to an assembly, wherein the fin portion projects vertically upward past the plurality of battery cells.

In some aspects, the techniques described herein relate to an assembly, wherein the at least one divider is sandwiched between a plurality of porous spacers along the cell stack axis.

In some aspects, the techniques described herein relate to an assembly, wherein the porous spacers are foam.

In some aspects, the techniques described herein relate to an assembly, wherein the porous spacers are aerogel.

In some aspects, the techniques described herein relate to an assembly, wherein the plurality of compartments are fluidly isolated from each other.

In some aspects, the techniques described herein relate to an assembly, wherein the at least one cell stack includes a first cell stack and a second cell stack, and further including a cross-member assembly disposed between the first and second cell stacks.

In some aspects, the techniques described herein relate to an assembly, wherein plurality of compartments are configured to vent through at least one opening in the cross-member assembly into an interior of the cross-member assembly.

In some aspects, the techniques described herein relate to a method of establishing a vent path within a battery pack, including: within a battery pack enclosure, using at least one divider of a cell stack to compartmentalize an interior area of the battery pack enclosure into a plurality of compartments, each of the compartments housing at least one battery cell of the cell stack.

In some aspects, the techniques described herein relate to a method, further including biasing the at least one divider against a portion of the battery pack enclosure.

In some aspects, the techniques described herein relate to a method, wherein the portion of the battery pack enclosure is an enclosure cover.

In some aspects, the techniques described herein relate to a method, further including flexing the at least one divider when biasing the at least one divider against the portion of the battery pack enclosure.

In some aspects, the techniques described herein relate to a method, wherein the flexing is a flexing of a fin portion of the at least one dividers, the fin portion projecting outward from the cell stack axis past the at least one battery cell of the cell stack, the fin portion including a first section bent toward an axial end of the cell stack, and a second section bent away from the axial end of the cell stack.

In some aspects, the techniques described herein relate to a method, further including venting gas from at least one battery cell from a given one of the compartments into an interior of a cross-member assembly that is within the interior area.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 and schematically showing cell stacks of the battery pack.

FIG. 3 illustrates a section view taken at line 3-3 in FIG. 2.

FIG. 3A illustrates a close-up of an area of FIG. 3.

FIG. 4 illustrates a perspective view of a portion of a cell stack from the battery pack of FIG. 2 alongside a portion of a cross-member assembly from the battery pack of FIG. 2.

FIG. 5 illustrates a top, schematic view of gas and debris venting from a compartment into the cross-member assembly shown in FIG. 4.

### DETAILED DESCRIPTION

This disclosure details exemplary methods and systems of compartmentalizing an interior area of a traction battery pack. The compartmentalizing can help to contain and direct gas and debris vented from one or more battery cells during a thermal event. Guiding the vented gas and debris away from other battery cells—other battery cells that are not venting—can help to prevent the thermal event from cascading to those other battery cells.

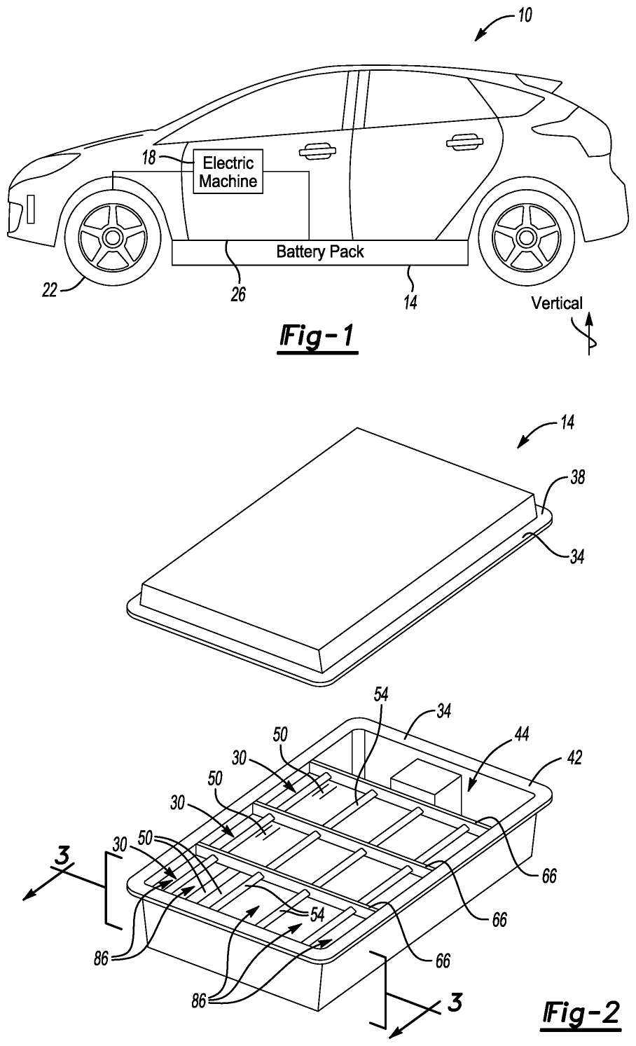

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

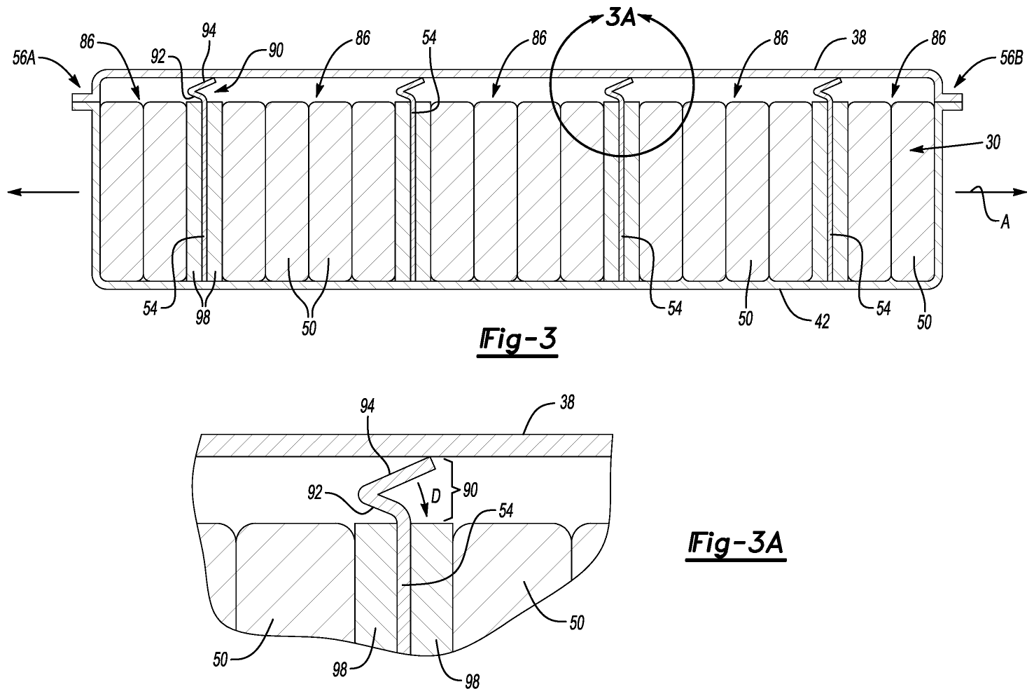

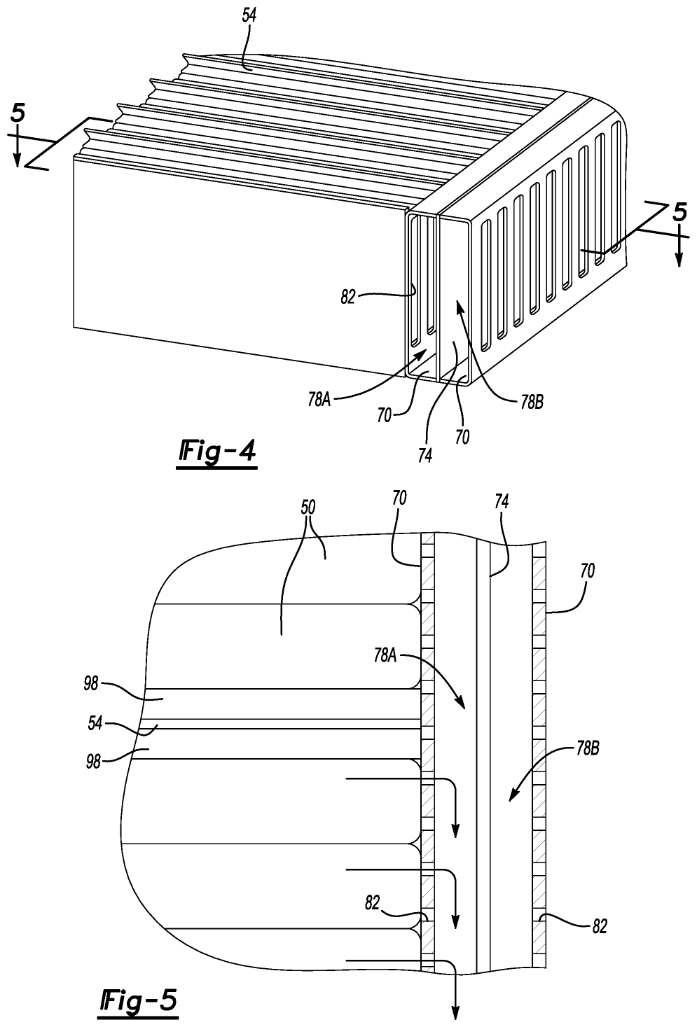

With reference now to FIGS. 2-5, the battery pack 14 includes a plurality of cell stacks 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply, “cells”) and at least one divider 54 distributed along a respective cell stack axis A. The cell stacks 30 each extend from a first axial end 56A to an opposite, second axial end 56B.

Within each cell stack 30, the battery cells 50 are stacked side-by-side relative to each other along the cell stack axis A. The battery cells 50 store and supply electrical power. Although specific numbers of the cell stacks 30 and cells 50 are illustrated in the various figures of this disclosure, the battery pack 14 could include any number of the cell stacks 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The example battery cells 50 can include a tab terminals extending from a housing. An aluminum film can provide the housing, for example.

From time to time, pressure and thermal energy within one or more of the battery cells 50 can increase. The pressure and thermal energy increase can be due to an overcharge condition, for example. The pressure and thermal energy increase can cause the associated battery cell 50 to rupture and release gas and debris.

The gases and debris can be released from the associated battery cell 50 through a designated vent within the housing, such as a membrane that yields in response to increased pressure, or through a ruptured area of the associated battery cell 50. If a designated vent, the vent could be positioned to direct a flow of vented gas and debris away from terminals of the battery cells 50.

The battery pack 14, in these examples, includes cross-member assemblies 66 disposed between cell stacks 30. The example cross-member assemblies 66 extend longitudinally in a direction that is parallel to the cell stack axes A. The cross-member assemblies 66 and the cell stack axes A extend in a cross-vehicle direction (i.e., from a driver side to a passenger side).

In this example, the cross-member assemblies 66 include two beams 70 sandwiching a barrier 74. The two beams 70 have a “C” shaped cross-section in this example, and are positioned to provide a first passageway 78A within the cross-member assemblies 66 on a first side of the barrier 74, and another, second passageway 78B within the cross-member assemblies 66 on an opposite, second side of the barrier 74.

The cross-member assemblies 66 include a plurality of openings 82 within each of the beams 70. Gas and debris vented from inside the battery cells 50 can move through at least one of the openings 82 into a passageway 78A or 78B within the cross-member assemblies 66. The gas and debris are communicated though the passageway 78A or 78B to an area outside the battery pack 14.

To help direct the gas though the openings 82 of the cross-member assembly 66, the dividers 54 projects outward from the cell stack axis A past the plurality of battery cells 50. In this example, the dividers 54 project outward far enough to contact the battery pack enclosure 34. In some examples, the area of the battery pack enclosure 34 contacted by the dividers 54 is lined with an organic paper.

Extending the dividers 54 to the enclosure 34 and beam 70 compartmentalizes the interior area 44 into a plurality of compartments 86.

The dividers 54 maybe bonded to the enclosure 34 and beam 70 to seal compartment 86. The adhesive could be epoxy based, silicone based or acrylic based with additives resistant to thermal energy. The bonding of divider 54 to enclosure 34 and beam 70 helps to improve torsional and bending stiffness of the pack. Each of these compartments 86 holds at least one of the battery cells 50 of a given one of the cell stacks 30. In this example, three of the compartments 86 each hold four of the battery cells 50 of a given cell stack 30, and two of the compartments 86 hold two of the battery cells 50 of the given cell stack 30. Each of the compartments 86 is fluidly isolated from the other compartments 86. The cross-member assemblies 66 and the enclosure 34 establish other boundaries of the compartments 86.

Gas and debris vented from one or more of the battery cells 50 in a given one of the compartments 86 is guided through one of the openings 82 into the passageway 78A of the cross-member assembly 66 rather than flowing over battery cells 50 outside the given one of the compartments 86. Gas flowing over the battery cells 50 could lead to a thermal event in those battery cells 50 in the other compartments 86.

The openings 82 in the beams 70 could each be covered by a membrane, for example. The membrane ruptures to permit gas to flow from one of the compartments 86 into the passageway 78A or 78B. The membrane prevents vented gas from flowing from the passageways 78A or 78B back through one of the openings 82 into one of the compartments 86 holding cells 50 that are not venting.

In this example, the dividers 54 each include a fin portion 90 that projects outward from the cell stack axis A past the plurality of battery cells 50. The example fin portion 90 projects vertically upward past the plurality of battery cells 50 and contacts the enclosure cover 38. Vertical, for purposes of this disclosure, is with reference to ground and a general orientation of the electrified vehicle 10 during operation.

The example fin portion 90 includes a first section 92 bent toward the axial end 56A of the cell stack 30, and a second section 94 bent away from the axial end 56A of the cell stack 30. Using both the first section 92 and the second section 94 can facilitate biasing. In another example, the fin portion 90 includes only the first section 92, but the first section 92 is extended so that the first section 92 can contact the enclosure cover 38.

When securing the enclosure cover 38 to the enclosure tray 42, the enclosure cover 38 is drawn closer to the enclosure tray 42 and presses downward against the fin portions 90. This flexes the example fin portions 90 in a direction D (FIG. 3A).

The example dividers 54 are a metal or metal alloy, such as aluminum. The dividers 54 are nominally one millimeter thick in this example. In another example, the dividers 54 could be a polymer-based material or another type of non-metal material.

When the enclosure cover 38 is secured to the enclosure tray 42, the fin portions 90 are biased against the enclosure cover 38. The biasing helps to seal the compartments 86 from each other. Although biased against the enclosure cover 38 in this example, the dividers 54 could instead be biased against another part of the enclosure 34. In some examples, the dividers 54 can instead or additionally be adhered to the enclosure cover 38 or the enclosure tray 42.

In the example embodiment, the cell stacks 30 each include a plurality of spacers 98. The dividers 54 are each sandwiched between a pair of the spacers 98. The example spacers 98 are porous spacers that are foam or aerogel. The spacers 98 can help to inhibit thermal energy transfer from one compartment 86 to another. The spacer 98 may be an insulating material if needed to reduce heat transfer from a cell stack 30 that is venting to a neighboring cell stack 30 that is not yet venting. The spacer 98 may also act as a compliant layer to allow some lower restriction to cell swelling and expansion at first, then compress to offer a higher restriction to cell swelling and expansion as the cells attempt to swell more over time and use. The spacer 98 may also act as a compliant barrier to further seal between cell stacks 3 where the second section 94 does not perfectly or securely close against the enclosure 34.

In these examples, the compartmentalizing is accomplished using the fin portions 90 of the divider 54. In another example, structures separate from the dividers 54 could be used. For example, strips of foam could be positioned between the enclosure 34 and the cell stacks 30 to compartmentalize the interior area 44. The strips of foam are distributed along an axis of the cell stack even thought the strips of foam may not extend between any cells of the cell stack.

A method of establishing a vent path for one or more of the battery cells 50 thus includes using at least one of the dividers 54 of the cell stacks 30 to compartmentalize the interior area 44 of the battery pack enclosure 34 into the compartments 86. Each of the compartments 86 houses one or more of the battery cells 50. The method can include biasing the dividers 54 against a portion of the battery pack enclosure 34—here the enclosure cover 38.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a battery pack enclosure that provides an interior area; and
at least one cell stack that includes a plurality of battery cells and at least one divider distributed along a cell stack axis, the at least one divider compartmentalizing the interior area into a plurality of compartments, each of the compartments holding at least one of the battery cells.

2. The assembly of claim 1, wherein the at least one divider is biased against the battery pack enclosure.

3. The assembly of claim 1, wherein the at least one divider is biased against an enclosure cover of the battery pack enclosure.

4. The assembly of claim 1, wherein the at least one divider is adhered to the battery pack enclosure, a beam of the battery pack enclosure, or both.

5. The assembly of claim 1, wherein the at least one divider is at least one metal or metal alloy divider.

6. The assembly of claim 1, wherein the at least one divider includes a fin portion that projects outward from the cell stack axis past the plurality of battery cells.

7. The assembly of claim 5, wherein the fin portion includes a first section bent toward an axial end of the cell stack, and a second section bent away from the axial end of the cell stack.

8. The assembly of claim 5, wherein the fin portion projects vertically upward past the plurality of battery cells.

9. The assembly of claim 1, wherein the at least one divider is sandwiched between a plurality of porous spacers along the cell stack axis.

10. The assembly of claim 8, wherein the porous spacers are foam.

11. The assembly of claim 8, wherein the porous spacers are aerogel.

12. The assembly of claim 1, wherein the plurality of compartments are fluidly isolated from each other.

13. The assembly of claim 1, wherein the at least one cell stack includes a first cell stack and a second cell stack, and further comprising a cross-member assembly disposed between the first and second cell stacks.

14. The assembly of claim 12, wherein plurality of compartments are configured to vent through at least one opening in the cross-member assembly into an interior of the cross-member assembly.

15. A method of establishing a vent path within a battery pack, comprising:
within a battery pack enclosure, using at least one divider of a cell stack to compartmentalize an interior area of the battery pack enclosure into a plurality of compartments, the compartments each house at least one battery cell of the cell stack.

16. The method of claim 14, further comprising biasing the at least one divider against a portion of the battery pack enclosure.

17. The method of claim 15, wherein the portion of the battery pack enclosure is an enclosure cover.

18. The method of claim 15, further comprising flexing the at least one divider when biasing the at least one divider against the portion of the battery pack enclosure.

19. The method of claim 17, wherein the flexing is a flexing of a fin portion of the at least one dividers, the fin portion projecting outward from a cell stack axis past the at least one battery cell of the cell stack, the fin portion including a first section bent toward an axial end of the cell stack, and a second section bent away from the axial end of the cell stack.

20. The method of claim 14, further comprising venting gas from at least one battery cell from a given one of the compartments into an interior of a cross-member assembly that is within the interior area.
